(19) United States
(12) Patent Application Publication
(10) Pub. No.: US 2023/0058567 A1
(43) Pub. Date: Feb. 23, 2023

(54) PEF COOKING APPLIANCE AND REMOVABLE CONTAINER FOR PRODUCTS TO BE COOKED THEREFOR

(71) Applicant: BSH Hausgeräte GmbH, Munich (DE)

(72) Inventors: Uwe Has, Unterneukirchen (DE); Barbara Heikel, Traunstein (DE); Arnulf Himmel, Traunreut (DE); Bernhard Koch, Inzell (DE); Manfred Steinbacher, Inzell (DE); Edith Wrehde, Nußdorf (DE)

(21) Appl. No.: 17/797,136

(22) PCT Filed: Mar. 3, 2021
(86) PCT No.: PCT/EP2021/055273

§ 371 Date: Aug. 3, 2022

(30) Foreign Application Priority Data
Mar. 19, 2020 (DE) 10 2020 203 518.0

(51) Int. Cl. H05B 6/62; A23L 5/10; A47J 27/00; H05B 6/50

(52) U.S. Cl. CPC H05B 6/62; A23L 5/15; A47J 27/004; H05B 6/50; A23V 2002/00

(57) ABSTRACT

A removable container for a product to be cooked for use in a PEF cooking appliance has a treatment chamber including at least two PEF electrodes between which a product to be cooked can be introduced and to which PEF signals pulsed with alternating polarity can be applied. Further provided are a sensor and a sensor circuit which includes an energy supply device configured without battery and DC-isolated from the PEF cooking appliance, an evaluation circuit connected to the sensor and the energy supply device, and a data transmission device connected to the evaluation circuit and the energy supply device. The data transmission device is configured to transmit data received from the evaluation circuit to the PEF cooking appliance in a non-electrical manner.

The invention relates to a removable container for products to be cooked for use in a PEF cooking appliance, having at least two capacitor plates, between which products to be cooked can be introduced and to which PEF signals pulsed with alternating polarity can be applied, and at least one sensor arranged on the container for products to be cooked. The invention further relates to a PEF cooking appliance for receiving the container for products to be cooked. The invention is advantageously applicable, in particular, to household appliances.

PEF (“Pulsed Electric Field”) cooking, i.e. the cooking of products to be cooked or food by means of pulsed voltage pulses (“PEF pulses”) is known in principle. In this case, the PEF pulses are applied to flat PEF electrodes of a container for products to be cooked, which, as a result of the contact of the PEF electrodes with the contents of the container for products to be cooked, generate an electric current through the contents of the container for products to be cooked. The contents typically comprise liquid products to be cooked, such as soup, or products to be cooked which have been placed into a water bath. The generated current also flows through the products to be cooked, whereby it is cooked.

For example, WO 2016/008868 A1 relates to a method for PEF (“Pulsed Electric Field”) cooking of a food product in a treatment chamber, wherein the treatment chamber comprises two opposing walls which in each case form an electrode. The method comprises the following steps: (a) placing a quantity of the food product, optionally in a surrounding liquid, in the treatment chamber between the two electrodes so that the food product and/or the surrounding liquid are in direct contact with the electrodes; and (b) applying electrical pulses, which are generated by a pulsed electrical field generator, onto the electrodes, so that the food product is subjected to a pulsed electrical field having a field strength of 10 to 180 V/cm and the total cooking time is 0.5 to 1000 s. Preferably, the number of pulses is 1 to 2000000 and the pulses have in each case a duration of 1 to 20000 microseconds. The food product and, if present, the surrounding liquid have an electric conductivity of 0.01 to 10 S/m. WO 2016/008868 A1 also relates to a cooking system which is suitable for cooking a food product according to such a method.

In PEF cooking, as in other cooking methods, it is advantageous if the progress of the cooking is able to be monitored, for example in order to adapt operating parameters during the PEF cooking (for example in order to adapt a type and an extent of the energy supply, for example by varying a duration and/or frequency of the PEF pulses) in order to determine particularly accurately when the end of the cooking occurs and/or when unplanned developments occur, in order to intervene in the cooking process so as to take corrective action. To this end, sensors are frequently used.

When using sensors which are arranged on a removable container for products to be cooked, the problem occurs that the high voltage provided by the voltage pulses (which may be several hundred volts) must not be carried into the (remaining) PEF cooking appliance via the sensors. This could occur, however, if the sensors for supplying energy or transmitting data were to be connected via electrical contacts to the PEF cooking appliance. If, on the other hand, sensors are attached to the container for products to be cooked in a manner which is electrically insulated from the remaining cooking appliance, the remaining appliance is safely disconnected from the high voltage but there is no energy available by means of which these sensors are able to be operated.

A remedy is available in sensors which are able to monitor remotely the container for products to be cooked or the contents thereof by contactless measurement, for example IR sensors for temperature measurement. A drawback, however, is that there are many measurement parameters which are not able to be be measured remotely, for example a conductivity of a contents of the container for products to be cooked. These sensor systems require a separate energy supply. The same applies to sensors which have to be arranged at least in the vicinity of the container for products to be cooked. This relates, for example, to overflow sensors which identify whether liquid or foam is escaping from the container for products to be cooked, i.e. whether the container for products to be cooked is boiling over in any manner.

One possibility for supplying sensors with energy independently is to provide a battery which is located on the container for products to be cooked. This disadvantageously assumes that the battery is always able to be replaced by a user but this is undesirable for practical reasons such as user-convenience. Moreover, a problem may occur if the battery fails during a cooking process.

It is the object of the present invention to overcome at least partially the drawbacks of the prior art and, in particular, to provide a possibility for operating sensors arranged on a container for products to be cooked in a manner which is operationally reliable and user-friendly.

This object is achieved according to the features of the independent claims. Advantageous embodiments form the subject of the dependent claims, the description and the drawings.

The object is achieved by a removable container for products to be cooked (also able to be denoted as the “PEF container for products to be cooked”) for use in a PEF cooking appliance, having
a treatment chamber having at least two PEF electrodes between which products to be cooked can be introduced and to which PEF signals pulsed with alternating polarity can be applied,
at least one sensor, and
a sensor circuit comprising an energy supply device without a battery and DC-isolated from the PEF cooking appliance, an evaluation circuit connected to the at least one sensor and the energy supply device, and a data transmission device connected to the evaluation circuit and the energy supply device, said data transmission device being set up to transmit data received from the evaluation circuit to the PEF cooking appliance in a non-electrical manner.

As a result, the advantage is achieved that no electrical connection is present between the at least one sensor and the remaining PEF cooking appliance, even in the inserted state of the container for products to be cooked. As a result, the high-voltage PEF signals fed into the container for products to be cooked are prevented from being able to jump over into the PEF cooking appliance via the at least one sensor. This advantageously increases the operational reliability.

The fact that the container for products to be cooked is removable means that, in particular, a user is able to remove it from the PEF cooking appliance, for example for filling with products to be cooked or with water and products to be cooked or for cleaning, and insert it again into the PEF cooking appliance. The container for products to be cooked has at least two connection contacts for feeding the PEF signals generated by the PEF cooking appliance.

The PEF electrodes are typically located so as to be electrically insulated from one another in the region of a wall of the container for products to be cooked and receive between one another products to be cooked which have been introduced therein. The PEF signals are conducted via the connection contacts to the respective PEF electrodes. The PEF electrodes are configured, in particular, as capacitor plates—which are specifically arranged parallel to one another. One development is that the capacitor plates are oriented vertically. The capacitor plates may be arranged in a stationary or displaceable manner in the treatment chamber.

The PEF signals are formed as electrical pulses with alternating polarity, i.e. the voltage direction of successive PEF signals or PEF pulses is reversed (“commutated”), i.e. for example in a PEF signal a first PEF electrode acts as a plus pole and the second PEF electrode acts as a minus pole, whilst in a following PEF signal the first PEF electrode acts as a minus pole and the second PEF electrode acts as a plus pole, etc. This sequence of the PEF pulses may be regarded as a pulsed alternating voltage signal. One development is that a pause is inserted between two successive PEF signals.

The container for products to be cooked may generally also have more than two PEF electrodes, in particular more than two pairs of PEF electrodes.

The at least one sensor may comprise one or more sensors. At least one sensor may protrude into the container for products to be cooked. At least one sensor may protrude into the contents thereof when the container for products to be cooked is filled (for example a temperature sensor, a level sensor and/or a conductivity sensor). At least one sensor may be disposed such that it is arranged on the container for products to be cooked spaced apart from the contents (for example an overflow sensor, a temperature sensor and/or a level sensor). The at least one sensor is connected to the sensor circuit. One development is that at least one sensor is arranged on the treatment chamber.

The sensor circuit serves to receive measurement signals detected by the at least one sensor, and to transmit the measurement signals optionally after processing (for example an A/D conversion) as measurement data in a non-electrical manner to the PEF cooking appliance. The sensor circuit is a component of the container for products to be cooked and is removed together with the container for products to be cooked from the PEF cooking appliance.

To this end, the sensor circuit is arranged outside the treatment chamber of the container for products to be cooked. One development is that the sensor circuit is arranged below the treatment chamber since this is particularly advantageous from a thermal perspective. One development is that the sensor circuit is encapsulated in a liquid-tight manner, so that the container for products to be cooked including the sensor circuit, for example, may also be washed in a dishwasher (“encapsulated to be dishwasher-safe”). The encapsulation may be implemented, for example, by encasing the sensor circuit with silicone.

The fact that the energy supply device is without a battery encompasses, in particular, that the energy supply device has no chemical energy store such as a battery or an accumulator (hereinafter only denoted as the “battery”). Thus the advantage is achieved that a user does not need to change a battery, which increases user convenience and an operational reliability. If the container for products to be cooked is removed from the PEF cooking appliance, without a battery the energy supply device is also no longer able to provide any electrical energy.

The evaluation circuit is supplied with electrical energy by the energy supply device. The energy supply device serves to process the received measurement signals, for example to digitalize, to value-convert said measurement signals, etc. (for example a voltage signal into a temperature value, conductivity value, etc.).

The data transmission device is also supplied with electrical energy by the energy supply device. The data transmission device may transmit the data received by the evaluation circuit (for example measurement data) and optionally further data such as status data without an electrical connection to the PEF cooking appliance. The data transmission device may transmit the data, for example
via radio (for example Bluetooth, NFC, WLAN, etc.),
inductively or by transformer (for example via a coil or transformer half),
optically (for example via a light-emitting diode) and/or
acoustically (for example as ultrasonic signals)

to the PEF cooking appliance. Due to the resulting DC-isolation from the PEF cooking appliance, PEF high voltage is not able to flash over to the PEF cooking appliance, even via the data connection.

The data transmission device is designed at least for the unidirectional transmission of data to the PEF cooking appliance. Generally, however, the data transmission device may also be designed to receive data (for example control commands) from the PEF cooking appliance, i.e. transmit data bidirectionally. Such control commands may encompass, for example, commands for the motorized movement of at least one of the PEF electrodes.

One embodiment is that the sensor circuit is able to be fed inductively with electrical energy from the PEF cooking appliance via an air gap. Specifically, the energy supply device may convert a magnetic alternating field emitted by a PEF cooking appliance into an induction voltage and use the induction voltage for supplying the sensor circuit with operating energy, optionally after a conversion (for example rectification, smoothing, stabilization, etc.). In other words, the energy supply device is designed for inductively receiving energy. To this end, the energy supply device may have at least one coil (“secondary coil”), whilst the PEF cooking appliance has a coil which is couplable thereto inductively or by transformer (“primary coil”). This is also known as transformer-based energy transmission when the two coils act as transformer halves.

If not only the operating energy or the effective energy required for operating the sensor circuit but also data is transmitted via these two coils (for example by modulation of the voltage or amplitude on the primary side and/or variation of the load on the secondary side) the data transmission device may be integrated in the energy supply device. Thus advantageously a dedicated data transmission device may be dispensed with.

One embodiment is that the sensor circuit is able to be fed with electrical energy by means of the pulsed PEF signals applied to the container for products to be cooked. In other words, energy for operating the sensor circuit is diverted from the PEF signals fed into the container for products to be cooked. This provides the advantage that the PEF cooking appliance may be designed in a particularly simple manner and additionally a particularly large amount of energy is available for operating the sensor circuit. Moreover, this embodiment may be implemented in a particularly compact and inexpensive manner.

One embodiment is that the sensor circuit is able to be supplied with voltage by means of a resistor (“series resistor”) connected in series to the PEF electrodes. As a result, advantageously it may be achieved in a simple manner that the voltage applied to the sensor circuit is lower than the high voltage of the PEF signals, which may be several hundred volts, optionally even 600 V or more. Moreover, this voltage tap is advantageously independent of a type and level of the internal resistance of the treatment chamber, i.e. of the contents introduced therein (products to be cooked and optionally liquid). In this case, the pulsed voltage tapped via the series resistor represents the input voltage for the sensor circuit.

One embodiment is that the sensor circuit is able to be supplied with voltage via a capacitive voltage divider connected to one of the PEF electrodes. This provides the advantage that losses may be kept particularly low and additionally the voltage supply of the sensor circuit advantageously is in this case independent of a type and level of the internal resistance of the treatment chamber.

One embodiment is that the sensor circuit is able to be supplied with voltage via a dedicated electrode (“additional electrode”) arranged between one of the PEF electrodes and a dedicated electrode arranged between the PEF electrodes in the treatment chamber. The additional electrode is arranged such that it also makes contact with the contents of the container for products to be cooked. This makes use of the fact that in the case of a container for products to be cooked which is filled with liquid, the liquid acts between the one PEF electrode and the additional electrode as a resistor series and thus a dedicated capacity for capacitive voltage division may be dispensed with. Moreover, advantageously the voltage thus tapped, which corresponds to a partial voltage of the pulse voltage applied to the two PEF electrodes, may be easily defined by a spacing between the additional electrode and the PEF electrode also used for the tapping.

One development is that the sensor circuit is directly applied to the one PEF electrode. One development is that the sensor circuit is applied via a series resistor to the one PEF electrode.

One embodiment is that the sensor circuit is able to be supplied with voltage via two additional electrodes arranged spaced apart from one another in the treatment chamber between the PEF electrodes. The voltage is thus supplied to the sensor circuit via the two additional electrodes. A connection to one of the two PEF electrodes may advantageously be dispensed with thereby. A further advantage is that a flash-over of the pulsed voltage to the sensor circuit, which is able to be applied to the PEF electrodes, is able to be prevented in a particularly effective manner.

One embodiment is that the energy supply device has a voltage rectifier, an energy store and/or a voltage stabilizer. This provides the advantage that the electrical and/or electronic components of the evaluation device and the data transmission device may be supplied with electrical energy in a particularly reliable manner.

Generally the type of sensors and/or the type of measurement variable(s) detected thereby are not limited and may comprise, for example:
a temperature sensor
a conductivity sensor
a level sensor and/or
an overflow sensor, etc.

The temperature sensor may be a sensor which makes contact with the contents of the container for products to be cooked, for example a thermocouple, and/or a contactlessly measuring temperature sensor, for example an IR sensor.

It is possible to draw conclusions about, for example, a salt content of a liquid present in the container for products to be cooked (for example water) from the measurement values of the conductivity sensor. In turn, it is possible to draw conclusions about the impedance of the contents of the treatment chamber from the conductivity.

The level sensor may have, for example, a float or a contactlessly measuring ultrasonic sensor.

The overflow sensor may be, for example, a foam sensor.

The object is also achieved by a PEF cooking appliance, having
a PEF signal generator for generating PEF signals polarized in a commutating manner,
a receiving space for the container for products to be cooked,
connection mating contacts connected to outputs of the PEF signal generator for making contact with connection contacts of the container for products to be cooked,
a data transmission device for receiving data from the data transmission device of the container for products to be cooked and
a control device which is connected to the data transmission device of the PEF cooking appliance and which is designed to control the PEF signal generator on the basis of the received data.

The PEF cooking appliance may be configured in a manner similar to the container for products to be cooked and has the same advantages.

Thus one embodiment is that the PEF cooking appliance has a coil for inductive or transformer-based coupling to the container for products to be cooked. The PEF cooking appliance in this case may have a primary coil for inductive or transformer-based coupling to a secondary coil of the container for products to be cooked.

For example, the control device may be designed to adapt the frequency of the pulsed PEF signals or PEF pulses on the basis of the received data.

The object is also achieved by a system having a PEF cooking appliance as described above with a container for products to be cooked introduced therein, as described above. The container for products to be cooked, however, may also be regarded as part of the PEF cooking appliance.

The above-described properties, features and advantages of this invention and the manner in which they are achieved will become clearer and more clearly comprehensible in connection with the following schematic description of an exemplary embodiment which is described in more detail in connection with the drawings.

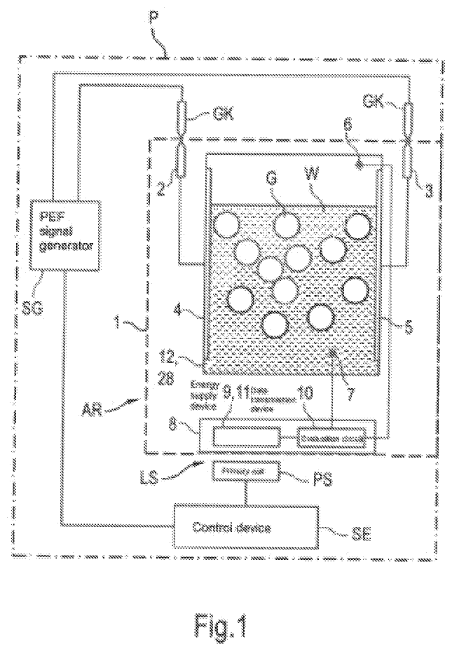

FIG. 1 shows as a sectional drawing in side view a simplified sketch of a PEF cooking appliance with a container for products to be cooked inserted therein according to a first exemplary embodiment;

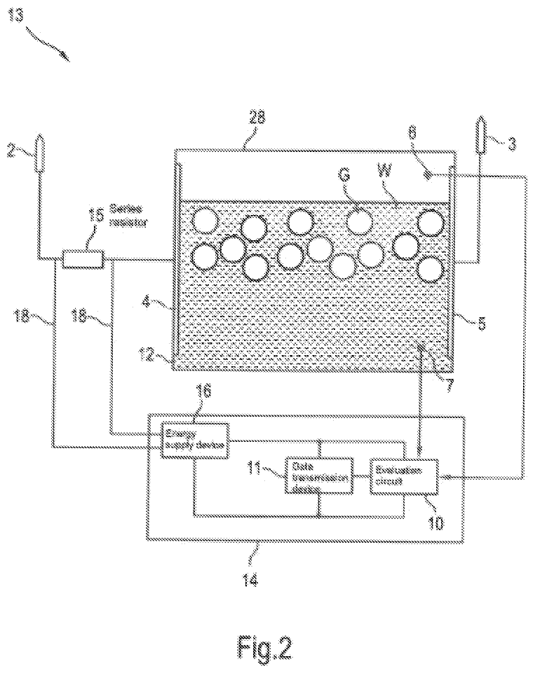

FIG. 2 shows as a sectional drawing in side view a simplified sketch of a container for products to be cooked according to a second exemplary embodiment;

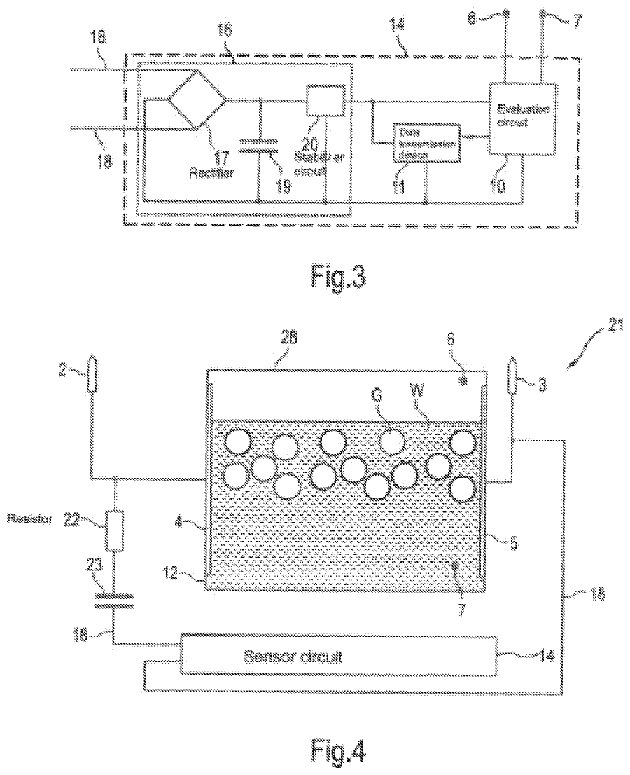

FIG. 3 shows a detailed sketch of a sensor device of the container for products to be cooked according to the second exemplary embodiment;

FIG. 4 shows as a sectional drawing in side view a simplified sketch of a container for products to be cooked according to a third exemplary embodiment;

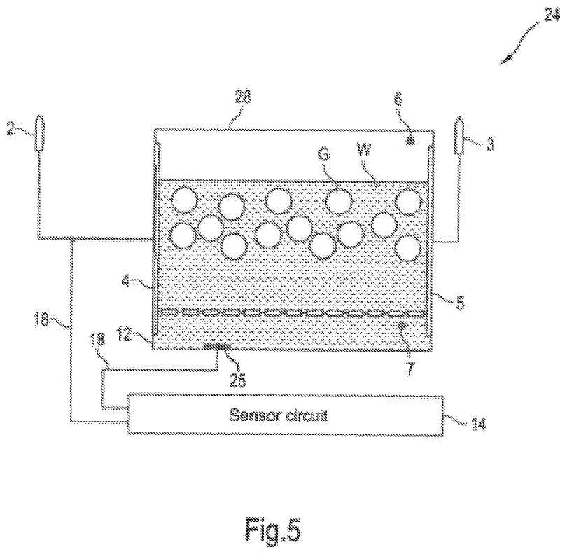

FIG. 5 shows as a sectional drawing in side view a simplified sketch of a container for products to be cooked according to a fourth exemplary embodiment; and

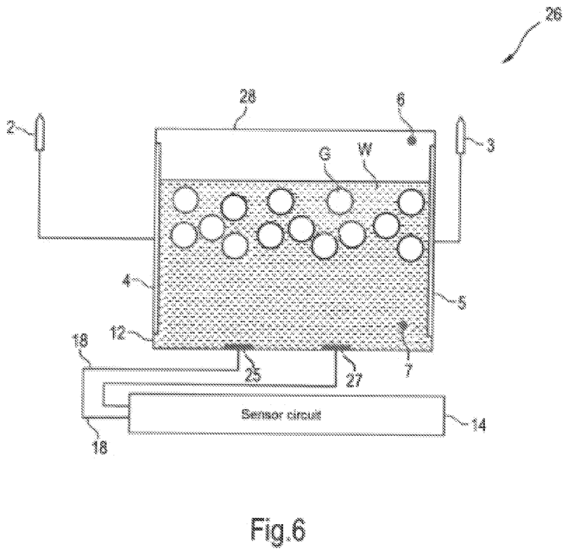

FIG. 6 shows as a sectional drawing in side view a simplified sketch of a container for products to be cooked according to a fifth exemplary embodiment.

FIG. 1 shows as a sectional drawing in side view a simplified sketch of a PEF cooking appliance P with a PEF container for products to be cooked 1 inserted therein, with a receiving space AR for the container for products to be cooked 1. The PEF cooking appliance P also has a PEF signal generator SG for generating pulsed PEF high voltage signals with alternating polarity, i.e. for generating a pulsed AC voltage. The signal outputs of the PEF signal generator SG are connected to respective connection mating contacts GK in the region of the receiving space AR, said connection mating contacts making contact with corresponding connection contacts 2, 3 of the container for products to be cooked 1 when the container for products to be cooked 1 is inserted.

The connection contacts 2, 3 of the container for products to be cooked 1 are connected to a first PEF electrode 4 or a second PEF electrode 5 of the container for products to be cooked 1 which are located in a treatment chamber 28 which can be filled with products to be cooked G and optionally water W and which is defined by an electrically non-conducting container wall 12. The PEF electrodes 4, 5 in this case are plate-shaped and vertically oriented. Products to be cooked G which have been introduced therein are located between the PEF electrodes 4, 5. The PEF electrodes 4, 5 are electrically insulated relative to one another by the container wall 12. The PEF signals are thus able to be applied to the PEF electrodes 4, 5, whereby a flow of current is generated between the PEF electrodes 4, 5 in the contents G, W of the container for products to be cooked 1, the products to be cooked G being able to be handled (cooked or heated) thereby in a manner known in principle.

The container for products to be cooked 1 also has one or more (in this case two) sensors 6 and 7, by means of which cooking parameters such as a temperature, a conductivity of the water W, a level of the water W, an overflow of the water W, etc. can be monitored. In the present case, the sensor 6 is arranged outside the space of the treatment chamber 28 taken up by the contents G, W of the container for products to be cooked 1, whilst the sensor 7 protrudes into this space.

The container for products to be cooked 1 also has a sensor circuit 8 which has an energy supply device 9 without a battery, an evaluation circuit 10 connected to the sensors 6, 7 and the energy supply device 9, and a data transmission device 11 connected to the evaluation circuit 10. In the present case, the energy supply device 9 is a device which is able to be fed inductively by a primary coil PS of the PEF cooking appliance P with electrical effective energy or operating energy and which has a pick-up coil (not shown) or secondary coil. The primary coil PS and the secondary coil form a coil pair, for example similar to transformer halves. The energy supply device 9 may also have a voltage rectifier 17, an energy store 18 and/or a voltage stabilizer 20 (see FIG. 3).

The energy supply device 9 supplies the evaluation circuit 10 with operating current, so that the evaluation circuit 10 may receive and process the measurement signals of the sensors 6, 7 (for example digitalize, optionally value-convert, etc.). The measurement data which is output by the evaluation circuit 10 (for example digitalized, optionally value-converted, etc.) is forwarded to the data transmission device 11 which transmits the measurement data in a non-electrical manner to the control device SE of the PEF cooking appliance P. The control device SE may control at least the PEF signal generator SG on the basis of the measurement data received thereby.

The data transmission device 11 in the exemplary embodiment shown uses the secondary coil for the data transmission to the PEF cooking appliance P, wherein the primary coil PS of the PEF cooking appliance P serves as a data receiving coil. During the transmission of data from the PEF cooking appliance P to the container for products to be cooked, the secondary coil serves as a data receiving coil.

The data transmission may thus also be carried out inductively, and the data transmission device 11 and the energy supply device 9 in this case are integrated in one another. If data is transmitted via the same coil pair as the operating energy, the data transmission may be carried out from the primary coil to the secondary coil, for example, by amplitude modulation and/or voltage modulation of the voltage applied to the primary coil PS, and with a transmission of data from the secondary coil to the primary coil may be carried out by modulation of the reduced load.

However, the data transmission may also be carried out inductively via a dedicated coil pair. In this case, the data transmission is advantageously carried out in order to avoid crosstalk between the effective energy coil pair and the data transmission coil pair, such that a carrier frequency used for the data transmission is located sufficiently far from the frequency of the inductive energy transmission and also from the frequency of the PEF current (also far removed from the respective first harmonics).

In the case of inductive energy and data transmission, the sensors 6, 7 are DC-isolated relative to one another from the PEF cooking appliance P via an air gap LS between the primary coil PS and the secondary coil. This also applies when using a dedicated data transmission coil pair.

Alternatively, a dedicated data transmission device 11 (not shown) may be present, said data transmission device being able to transmit data, for example via radio, optically, inductively or via sound to the PEF cooking appliance P. The PEF cooking appliance P thus may have a corresponding data receiving device (not shown) connected to the control device SE. A DC-isolation of the sensors 6, 7 from the PEF cooking appliance P is also achieved thereby.

FIG. 2 shows as a sectional drawing in side view a simplified sketch of a container for products to be cooked 13. The container for products to be cooked 13 differs from the container for products to be cooked 1 in that the sensor circuit 14 is not inductively supplied with energy by the PEF cooking appliance (not shown) but its energy (for example an operating current) required for operation is diverted from the PEF signals.

To this end, a resistor (“series resistor” 15) is electrically connected in series to the first PEF electrode 4, via which the supply voltage for the energy supply device 16 is tapped. The series resistor 15 may also be used to define a current (“treatment current”) flowing between the PEF electrodes 4, 5.

In the associated PEF cooking appliance (not shown) a primary coil is no longer present, but a data receiving device (not shown) connected to the control device SE is present, said data receiving device being able to communicate with the data transmission device 11 of the container for products to be cooked 13 and namely either unidirectionally for receiving measurement data, status data, etc., or bidirectionally for receiving measurement data, status data, etc. and for emitting control commands, etc. to the container for products to be cooked 13.

FIG. 3 shows a detailed sketch of the sensor circuit 14, in particular of the associated energy supply device 16. The energy supply device 16 has a rectifier 17, for example a Graetz circuit, the inputs thereof being connected to supply lines 18. The voltage tapped at the series resistor 15 is applied to the rectifier 17 via the supply lines 18.

A capacitor 19 is connected in parallel to the outputs of the rectifier 17. The capacitor serves to store and optionally to smooth energy of the rectified voltage pulse output from the rectifier 17.

A stabilizer circuit 20 is connected to the capacitor 19, said stabilizer circuit converting the voltage provided from the capacitor 19 into an operating voltage which is suitable (more suitable) for operating the evaluation circuit 10 and the data transmission device 11. The evaluation circuit 10 and the data transmission device 11 are connected downstream of the stabilizer circuit 20 and receive their operating voltage thereby.

FIG. 4 shows as a sectional drawing in side view a simplified sketch of a container for products to be cooked 21. The container for products to be cooked 21 differs from the container for products to be cooked 13, in that the energy supply device 16 is now connected via its supply lines 18, on the one hand, via a series connection of an ohmic resistor 22 and a capacitor 23 to the first PEF electrode 4 and, on the other hand, directly to the second PEF electrode 4. The resistor 22 serves to reduce the steepness of the flanks of the PEF pulses fed via the connection contact 2 and/or to reduce an input voltage into the energy supply device 16.

This exemplary embodiment is particularly advantageous since particularly low losses occur and additionally a type and level of an internal resistance between the PEF electrodes 4, 5 predetermined by the contents G, W are irrelevant.

FIG. 5 shows as a sectional drawing in side view a simplified sketch of a container for products to be cooked 24. The container for products to be cooked 24 differs from the container for products to be cooked 1, 13 and 21 in that the energy supply device 16 is arranged via its supply lines 18, on the one hand, on the first PEF electrode 4 and, on the other hand, on an electrode (“additional electrode” 25) which is arranged between the PEF electrodes 4, 5 and which makes contact with the contents G, W of the container for products to be cooked 24. The additional electrode 25 in this case is arranged on the bottom side of the container wall 12.

This makes use of the fact that the water W acts between the PEF electrodes 4, 5 as a (molecular) voltage divider, as indicated approximately by the illustrated resistor chain. The voltage applied to the energy supply device 16 thus corresponds at least approximately to a partial voltage of the voltage applied to the PEF electrodes 4, 5. This partial voltage is at least approximately proportional to the spacing between the additional electrode 25 and the first PEF electrode 4; if the additional electrode 25 is located, for example, in the center between the two PEF electrodes 4, 5, approximately half of the full PEF voltage is applied to the connection lines 18, if the additional electrode 25 is located relative to the first PEF electrode 4 at a third of the spacing between the two PEF electrodes 4, 5, approximately a third of the full PEF voltage is applied to the connection lines 18, etc.

FIG. 6 shows as a sectional drawing in side view a simplified sketch of a container for products to be cooked 26. The container for products to be cooked 26 differs from the container for products to be cooked 24 in that the energy supply device 16 is now connected via its supply lines 18 to two additional electrodes 25 and 27 which are arranged spaced apart from one another between the PEF electrodes 4, 5 and which make contact with the contents G, W of the container for products to be cooked 24. The two additional electrodes 25, 27 in this case are arranged by way of example on the bottom side of the container wall 12. In the view similar to FIG. 5, the partial voltage applied to the additional electrodes 25 and 27, and thus to the energy supply device 16, is at least approximately proportional to the spacing of the two additional electrodes 25 and 27 from one another, which is present in the perpendicular direction between the PEF electrodes 4, 5, divided by the spacing of the two PEF electrodes 4, 5: if the two additional electrodes 25, 27 have, for example, a spacing from one another which is half of the spacing between the two PEF electrodes 4, 5, approximately the half of the full PEF voltage is applied to the connection lines 18, etc. The smaller the spacing between the two additional electrodes 25, 27 the smaller the partial voltage applied thereto.

In the above figures, the sensor circuit 8, 14 is illustrated below the treatment chamber 28. This position has the advantage that lower temperatures are to be anticipated here than, for example, above the treatment chamber 28. Generally, however, the sensor circuit may be connected at any suitable point around the treatment chamber 28.

Naturally, the present invention is not limited to the exemplary embodiment shown.

Thus components and arrangements of the exemplary embodiments shown may also be combined together or exchanged with one another in any expedient manner. For example, the series circuit shown in FIG. 4, consisting of the resistor 22 and capacitor 23 of the container for products to be cooked 21, is also able to be used in the containers for products to be cooked 13, 24 and 26. Moreover, the series resistor 15 may also be installed, for example, in the containers for products to be cooked 1, 21, 24 and 26.

Generally “a”, “one” etc. may be understood to mean a singular or a plurality, in particular in the sense of “at least one”, or “one or more”, etc., provided this is not explicitly excluded, for example, by the expression “exactly one”.

List of reference characters

| | |
|---|---|
| 1 | Container for products to be cooked |
| 2 | Connection contact |
| 3 | Connection contact |
| 4 | First PEF electrode |
| 5 | Second PEF electrode |
| 6 | Sensor |
| 7 | Sensor |
| 8 | Sensor circuit |
| 9 | Energy supply device |
| 10 | Evaluation circuit |
| 11 | Data transmission device |
| 12 | Container wall |
| 13 | Container for products to be cooked |
| 14 | Sensor circuit |
| 15 | Series resistor |
| 16 | Energy supply device |
| 17 | Rectifier |
| 18 | Supply line |
| 19 | Capacitor |
| 20 | Stabilizer circuit |
| 21 | Container for products to be cooked |
| 22 | Resistor |
| 23 | Capacitor |
| 24 | Container for products to be cooked |
| 25 | Additional electrode |
| 26 | Container for products to be cooked |
| 27 | Additional electrode |
| 28 | Treatment chamber |
| AR | Receiving space |
| LS | Air gap |
| G | Products to be cooked |
| GK | Connection mating contact |
| P | PEF cooking appliance |
| PS | Primary coil |
| SE | Control device |
| SG | PEF signal generator |
| W | Water |

1-12. (canceled)

13. A removable container for a product to be cooked for use in a PEF cooking appliance, said removable container comprising:
a treatment chamber including at least two PEF electrodes between which a product to be cooked can be introduced and to which PEF signals pulsed with alternating polarity can be applied;
a sensor; and
a sensor circuit comprising an energy supply device configured without battery and DC-isolated from the PEF cooking appliance, an evaluation circuit connected to the sensor and the energy supply device, and a data transmission device connected to the evaluation circuit and the energy supply device, said data transmission device being configured to transmit data received from the evaluation circuit to the PEF cooking appliance in a non-electrical manner.

14. The container of claim 13, wherein the sensor circuit is able to be inductively fed with electrical energy from the PEF cooking appliance via an air gap.

15. The container of claim 13, wherein the sensor circuit is able to be fed with electrical energy via the pulsed PEF signals applied to the container.

16. The container of claim 13, further comprising a series resistor which is connected in series to the PEF electrodes and via which the sensor circuit is able to be supplied with voltage.

17. The container of claim 13, further comprising a capacitive voltage divider which is connected to one of the at least two PEF electrodes and via which the sensor circuit is able to be supplied with voltage.

18. The container of claim 13, further comprising an additional electrode arranged in the treatment chamber between the at least two PEF electrodes, said sensor circuit being able to be supplied with voltage between one of the at least two PEF electrodes and the additional electrode.

19. The container of claim 13, further comprising two additional electrodes arranged spaced apart from one another in the treatment chamber between the at least two PEF electrodes, said sensor circuit being able to be supplied with voltage via the two additional electrodes.

20. The container of claim 13, wherein the energy supply device includes at least one of a voltage rectifier, an energy store, and a voltage stabilizer.

21. The container of claim 13, wherein the data transmission device is configured to transmit data based on radio, by inductive coupling, optically and/or acoustically.

22. The container of claim 13, wherein the sensor comprises at least one of a temperature sensor, a conductivity sensor, a level sensor, and an overflow sensor.

23. A PEF cooking appliance, comprising:
a PEF signal generator configured to generate PEF signals polarized in a commutating manner,
a receiving space for accommodating a container for a product to be cooked;
connection mating contacts connected to outputs of the PEF signal generator for making contact with connection contacts of the container,
a data transmission device configured to receive data from the container and
a control device connected to the data transmission device and designed to control the PEF signal generator based on the date received from the data transmission device.

24. The PEF cooking appliance of claim 23, further comprising a coil for inductive or transformer-based coupling to the container.
